(19) United States
(12) Patent Application Publication
(10) Pub. No.: US 2017/0117538 A1
(43) Pub. Date: Apr. 27, 2017

(54) NANOCOMPOSITE ANODE STRUCTURE AND METHODS OF MANUFACTURE THEREOF

(71) Applicants: Karim Bendimerad, San Francisco, CA (US); Karel Vanheusden, Woodside, CA (US)

(72) Inventors: Karim Bendimerad, San Francisco, CA (US); Karel Vanheusden, Woodside, CA (US)

(73) Assignee: Ensor, Inc., Menlo Park, CA (US)

(21) Appl. No.: 14/922,012

(22) Filed: Oct. 23, 2015

(51) Int. Cl. H01M 4/36; H01M 4/134; H01M 4/133; H01M 4/04; H01M 4/583; H01M 4/1395; H01M 4/1393; H01M 4/62; H01M 10/0525; H01M 4/38

(52) U.S. Cl. CPC H01M 4/366; H01M 10/0525; H01M 4/134; H01M 4/133; H01M 4/386; H01M 4/583; H01M 4/1395; H01M 4/1393; H01M 4/625; H01M 4/0471; H01M 2004/027

(57) ABSTRACT

A nanocomposite anode structure and methods of manufacture thereof are disclosed. The nanocomposite comprises a set of substantially dispersed nanoparticles configured to absorb and release lithium ions, wherein each nanoparticle of the set of nanoparticles comprises a core and a shell physically coupled to the core, the core further comprising a set of bonded silicon atoms, the shell further comprising a set of bonded carbon atoms, wherein a core diameter is less than 20 nm, and wherein the shell has a thickness of about 0.1 to about 2 nm. And a set of electrically coupled carbon particles substantially dispersed in the nanocomposite, wherein the set of carbon particles is further electrically coupled with the set of nanoparticles.

### CROSS-REFERENCE TO RELATED APPLICATIONS

NONE

### FIELD OF DISCLOSURE

This disclosure relates in general to energy storage devices and in particular to a nanocomposite anode structure for use in such energy storage devices.

### BACKGROUND

Virtually every portable electronic device or electric vehicle requires an energy storage device, commonly a battery. However, portable devices and electric vehicles also have practical size and weight limitations, beyond which portability and mobility characteristics are diminished.

Perhaps the most ubiquitous material used in rechargeable portable energy storage devices today is lithium. The lightest of all metals, lithium generally has the greatest electrochemical potential and provides the largest specific energy per unit weight.

A lithium-ion battery uses a cathode (positive electrode), an anode (negative electrode) and electrolyte as ion conductor. The cathode generally comprises a metal oxide and the anode generally consists of porous carbon. During a discharge, the lithium ions flow from the anode to the cathode through the electrolyte and separator. A charge reverses the direction, and the lithium ions flow from the cathode to the anode.

Referring to FIG. 1, a simplified illustration is shown of the charge and discharge process in a simplified schematic view of a standard lithium-ion battery configuration. As the cell charges and discharges, ions shuttle between cathode 102 (positive electrode) and anode 104 (negative electrode) across separator 106 (typically a porous membrane). Electrolyte 108, typically a liquid, is the medium that facilitates the ion transport mechanism between the cathode 102 and anode 104. Power is directly related to the potential difference between cathode 102 and anode 104, whereas energy is related to both the power and the charge capacity of the cell.

Referring to FIG. 2, a simplified illustration is shown of a typical lithium ion battery, comprising a cathode assembly, anode assembly, and a separator. Cathode assembly 210 is generally comprised of cathode 205 that further includes a metal oxide, and an aluminum foil electrode 201 electrically and physically coupled to cathode 205. Anode assembly 212 is generally comprised of anode 206 that further includes a set of graphite particles 204, and a copper foil electrode 202 electrically and physically coupled to anode 206. Cathode assembly 210 and anode assembly 212 are further physically separated via by porous membrane separator 203.

Most present day lithium ion batteries use graphite as an anode material. Also used in lead pencils, graphite both provides a good storage structure for lithium-ions when the battery is charged and has long-term cycle stability.

However, as newer portable electronic devices increase in functionality and capacity, and as electric vehicles gain popularity, even greater power and energy, limited by rigid size, weight and cost requirements, are demanded. Currently, a typical lithium-ion battery has an energy density of about 150 mWh/cc (milliwatt-hours per cubic centimeter). Consequently, optimizing one of the battery components (anode, cathode, or electrolyte) without substantially diminishing or sub-optimizing portability would be beneficial.

In view of the foregoing, there is desire for a nanocomposite anode structure that optimizes the physical and electrical characteristics of a lithium-ion battery.

### SUMMARY

A nanocomposite anode structure and methods of manufacture thereof are disclosed. The nanocomposite comprises a set of substantially dispersed nanoparticles configured to absorb and release lithium ions, wherein each nanoparticle of the set of nanoparticles comprises a core and a shell physically coupled to the core, the core further comprising a set of bonded silicon atoms, the shell further comprising a set of bonded carbon atoms, wherein a core diameter is less than 20 nm, and wherein the shell has a thickness of about 0.1 to about 2 nm. And, a set of electrically coupled carbon particles substantially dispersed in the nanocomposite, wherein the set of carbon particles is further electrically coupled with the set of nanoparticles.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a schematic illustration is shown of the charge and discharge process in a simplified view of a standard lithium-ion battery configuration;

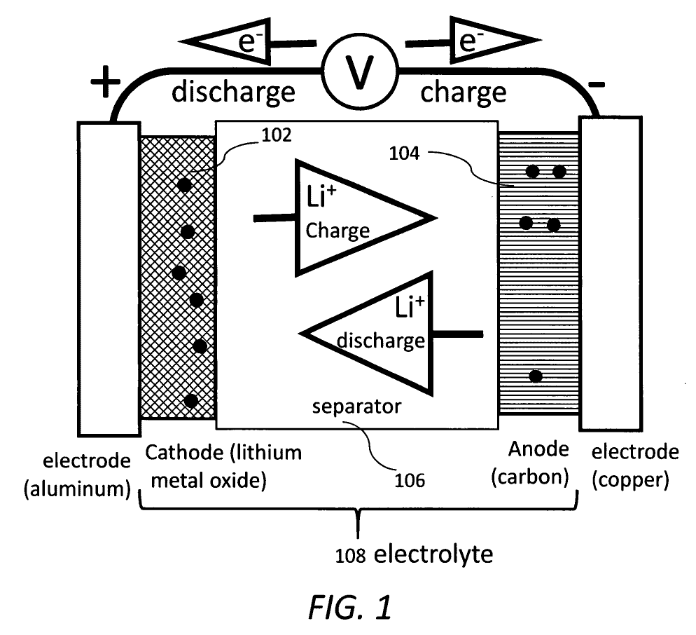

FIG. 2 shows a simplified schematic illustration of a typical lithium ion battery electrode assembly;

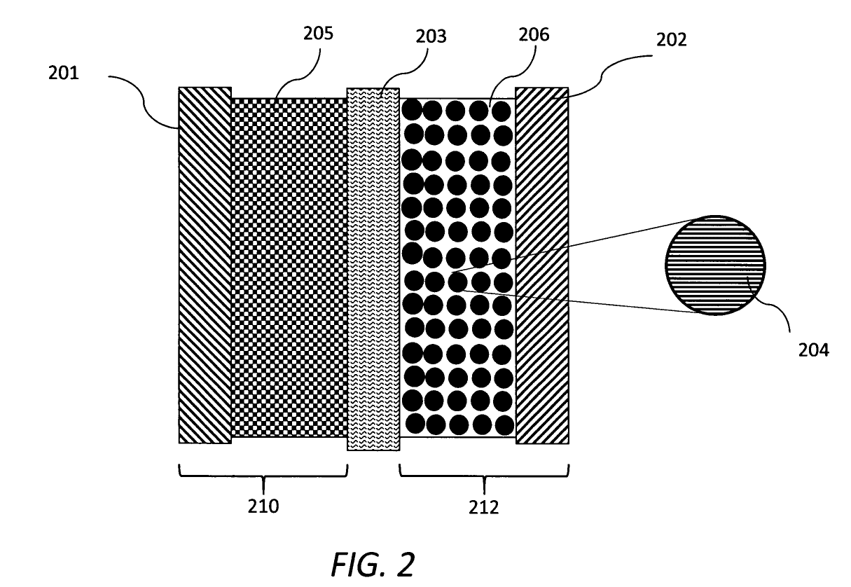

FIG. 3 shows a nanoparticle with a silicon core and a carbon shell, in accordance with the invention;

FIG. 4 shows a simplified diagram of a nanocomposite anode structure, formed as a hard agglomeration of core-shell particles, in accordance with the invention;

FIG. 5A shows a simplified diagram of a lithium ion battery electrode assembly incorporating a set of nanocomposite anode structures, in accordance with the invention;

FIG. 5B shows electrical conductivity of various single phase materials and composite materials;

FIG. 6 shows an example manufacturing process to form a set of nanocomposite anode structures, in accordance with the invention;

FIG. 7 shows a first alternative manufacturing process to form a set of nanocomposite anode structures, in accordance with the invention; and,

FIG. 8 shows a graph representing the melting temperature in Kelvin as a function of silicon nanoparticle size in nm.

### DETAILED DESCRIPTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In general, the lack of substantial innovation in lithium ion battery (LIB) materials is largely responsible for slowing progress in both cost reductions and performance improvements. In particular, graphite anode chemistry has not substantially changed since the introduction of the technology in 1991. Consequently, meaningful growth in various markets, including electric vehicles, and renewable energy storage has been limited.

Although graphite tends to be the material of choice of the LIB anode, the use of silicon, in contrast, may provide an order of magnitude higher lithium storage capacity. However, unlike graphite, silicon tends to experience over a 300% volume expansion upon lithiation leading to anode degradation and poor capacity retention with battery cycling. And although a broad range of silicon anode compositions (including silicon alloys, silicon nanowires, and silicon-carbon nanocomposites) have been investigated, the inventors believe that there has been no substantial technological breakthrough for a silicon based anode material prior to this invention.

In general, this failure is fundamentally linked to the inability of the proposed compositions and structures to control the large volume changes of the silicon phase, poor electronic transport properties of silicon, and to excessive chemical reactivity of the silicon surface towards the electrolyte.

The inventors believe that the present invention addresses these unresolved issues through a unique bottom-up synthesis approach that uses the unique properties of quantum size (1-10 nm) core-shell particles. In general, the synthesis and fabrication of quantum sized core-shell particles is difficult primarily due to silicon's strong tendency to form a very stable oxide. The current invention sets forth the use of gas phase nucleation and growth of silicon nanoparticles in an inert environment, followed by in-situ encapsulation with an organic ligand, to produce substantially oxide-free and air-stable nanoparticles.

In an advantageous manner, a nanocomposite anode structure may be formed comprising a set of silicon nanoparticles, each encapsulated in a carbon shell, with additional carbon particles and carbon additives. The inventors believe that the porous nanocomposite anode structure may both double lithium-ion storage capacity, and substantially reduce electrolyte interactions and excessive solid-electrolyte interphase (SEI) formation, which compete with reversible lithium intercalation

In accordance with the invention, silicon nanoparticles may be configured with a carbon shell in direct contact with the silicon core, without an interface layer of silicon dioxide commonly found between the silicon core and the carbon shell.

For example, the carbon shell maybe anchored to the silicon core through silicon carbon bonds. Si—C surface bonds generally provide good chemical stability during anode material manufacturing, storage, transportation, fabrication of the lithium ion battery, and battery operation. The presence of such bonds further tends to prevent disintegration or pulverization during charge/discharge of a battery. In addition, the carbon shell may provide good electrical contact between the silicon core and a carbon matrix. The carbon matrix being an electrically conductive carbon pathway provided by the carbon phase in the aggregate or composite particles. This arrangement will generally improve the electrical conductivity of an electrode containing the particles. Furthermore, the carbon shell, substantially encapsulating the silicon core, may provide chemical stability and compatibility with the other elements of the energy storage device.

In general, a silicon core is provided to predominantly store and release the lithium during operation. Certain silicon containing anodes can undergo significant volume changes during battery operation. This is attributed to the fact that insertion and extraction of lithium ions into bulk silicon may cause the silicon to significantly expand and contract.

In the current invention, a small silicon core size may be used to significant reduce the volumetric changes during lithium storage and release from the silicon core. This may be accomplished by the use of silicon nanoparticles with a core size of preferably less than 20 nm, more preferably less than 15 nm, or most preferably, less than 10 nm. It has been demonstrated that the large volume expansion and resulting mechanical strain of silicon based anodes can be significantly reduced by employing smaller, well-dispersed, core-shell nanoparticles embedded in a carbon matrix, as suggested in the literature. [See A Stable Silicon Anode Based on the Uniform Dispersion of Quantum Dots in a Polymer Matrix, L. Zhong et al., Journal of Power Sources 2015, Vol. 273, pp. 638-644, A Critical Size of Silicon Nano-Anodes for Lithium Rechargeable Batteries, H. Kim et al., Angew. Chem. 2010, Vol. 49, pp. 2146-2149, and Synthesis and Electrochemical Properties of Lithium-Electroactive Surface-Stabilized Silicon Quantum Dots, Y. Kwon et al., Electrochemica Acta 2007, Vol. 52, pp. 4663-4668].

In an advantageous manner, a silicon core may be modified by encapsulating it in a carbon shell, creating a conductive silicon carbon interface between the core and the shell.

In general, the silicon carbon bonds at the interface provide chemical stability during anode material storage, anode material transport, processing of the silicon core-shell particles into a silicon-carbon composite powder, battery assembly, and battery operation. The absence of silicon-oxygen bonds at the interface further increases the chemical stability as the silicon carbon bonds provide a more chemically inert surface as compared to an oxidized silicon surface. This is particularly important when processing is performed by dispersion of anode powder in an aqueous solution. The oxygen free interface is further provided to enhance the electrical contact between the silicon core and the carbon shell.

The carbon shell is further provided as a chemically stable surface to reduce reactivity with the electrolyte and with the lithium and with other elements of the energy storage device during its useful life. In general, useful life is defined as 500 cycles for consumer electronics applications and 2000-3000 battery cycles for automotive applications. The carbon shell preferably has a thickness of about 0.1 to about 2 nm, and further ideally has a high degree of crystallinity to provide adequate electrical conductivity and optimum anode performance. Electrical conductivity of the carbon shell should be high for adequate anode conductivity and power density.

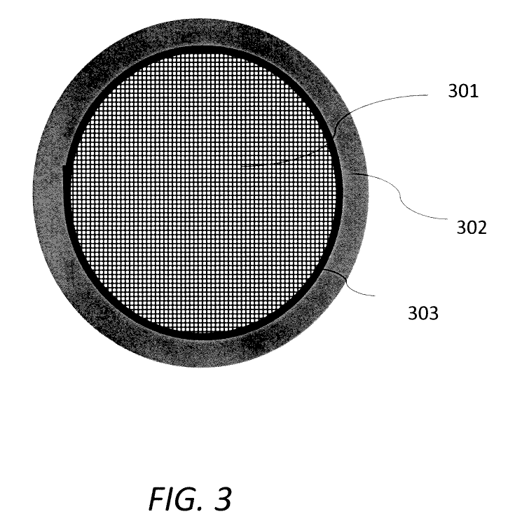

Referring now to FIG. 3, a simplified diagram of a nanoparticle with a silicon core and a carbon shell is shown in accordance with the invention. The core-shell particle comprises a silicon core 301, a carbon shell 302, and a core-shell interface 303. In general, the silicon core diameter is preferably less than about 20 nm, more preferably less than 15 nm, and most preferably less than about 10 nm. This size range is advantageous to minimize volume changes and fracturing of the carbon shell during battery operation. Silicon core 301 may be further single crystalline, poly crystalline, or amorphous Si. In addition, silicon core 301 may also incorporate silicon hydrogen bonds and/or silicon-oxygen bonds.

In general, the carbon shell 302 is preferentially configured with crystalline carbon such as graphene, and has a thickness of less than 5 nm, and a weight percentage of less than about 5 wt. % of silicon core 301, to provide both electrical conductivity and mechanical stability. In one embodiment, the carbon shell may be configured with graphitic carbon, hard carbon, soft carbon, or acetylene black. In another embodiment, the carbon shell may be configured as an amorphous carbon shell.

The core-shell interface 303 comprises silicon-carbon surface bonds and substantially less silicon-oxygen bonds. For example, the surface comprising about 20% S—C bonds and about 80% Si—Si bonds, and low concentrations of Si—O bonds, preferably less than 5% surface Si—O bonds or more preferably less than 1% surface Si—O bonds. In general, Si—O bonds are not desirable as they hinder electrical conductivity and are less stable as compared to Si—C bonds, particularly in the presence of moisture.

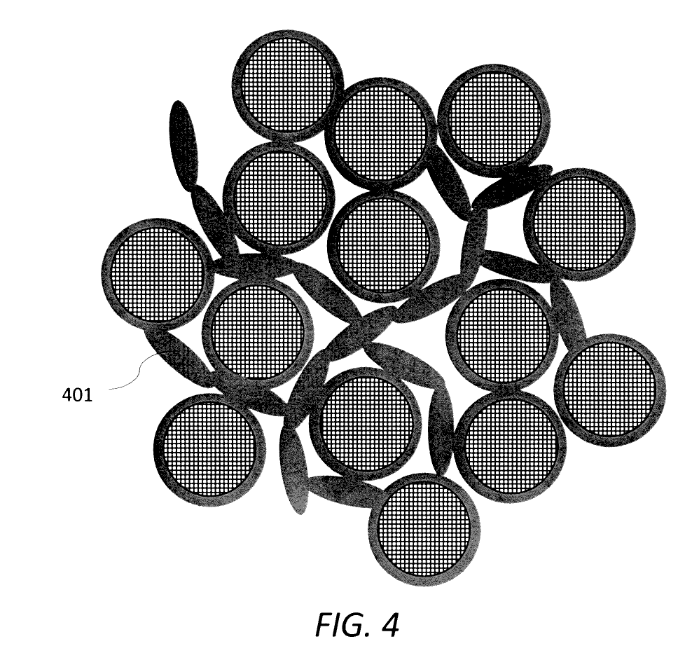

Referring now to FIG. 4, a simplified diagram of a nanocomposite anode structure, formed as a hard agglomeration of core-shell particles, is shown in accordance with the invention. In general, the composition of the carbon particles 401 is preferably carbon black such as acetylene black or Ketjen Black for optimum electrical conductivity. Alternatively, the composition of carbon particles 401 may also be soft carbon, hard carbon, graphite, graphene, carbon nanotubes, or other commercial forms of carbon.

In general, carbon particles 401, with high surface areas (i.e., over about 200 m²/g), tend to substantially increase electrical conductivity through the creation of an electrical percolation network with the core shell particles of the nanocomposite anode structure.

The addition of carbon particles 401 also tend to substantially create pores throughout the nanocomposite anode structure. In general, pores minimize the structural stress created during the expansion and contraction of the nanocomposite anode structure during the absorption and release of lithium ions.

In one embodiment, the pores are closed (that is, not substantially exposed electrolyte) to limit solid electrolyte interface (SEI) layer formation that would otherwise tend to form at the carbon shell as the electrolyte reacts with the carbon surface. Open pore volume may be further reduced by the addition of an amorphous carbon phase which may be created through the thermal decomposition of an organic binder such as for example a polymer such as Polyvinylpyrrolidone (PVP, also commonly called polyvidone or povidone), or Polyvinyl acetate (PVA, polyethenyl ethanoate). Such binders may be advantageously added in a weight ratio of up to 1:1 relative to the core-shell particle weight during formation of particle 400. The current invention describes a process (see below) to convert this binder at high temperature into an amorphous carbon residue. The residue will coat the core-shell particles and the added carbon particles 401, and may advantageously reduce open porosity. For example, PVP is known to decompose into a carbonaceous structure with a mass yield between 4% and 15% depending on the annealing conditions and on the presence of other additives mixed with the PVP.

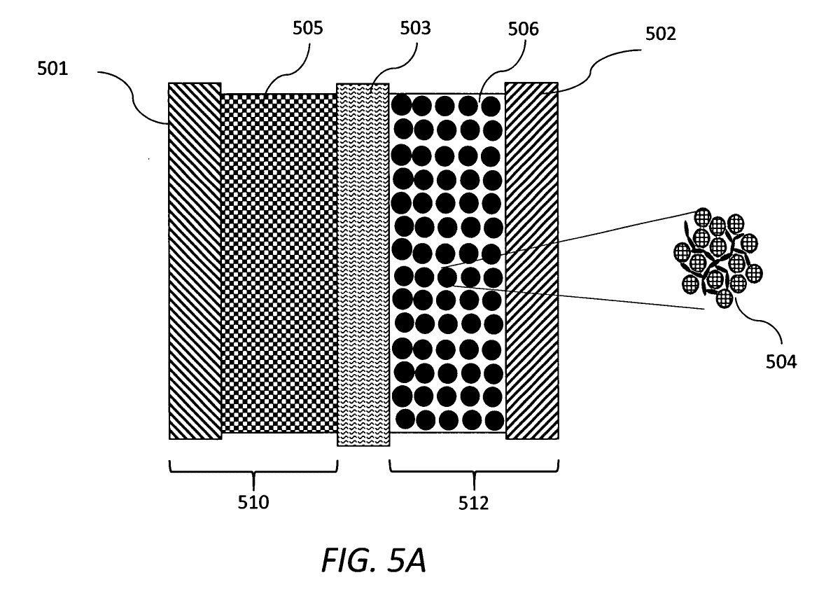

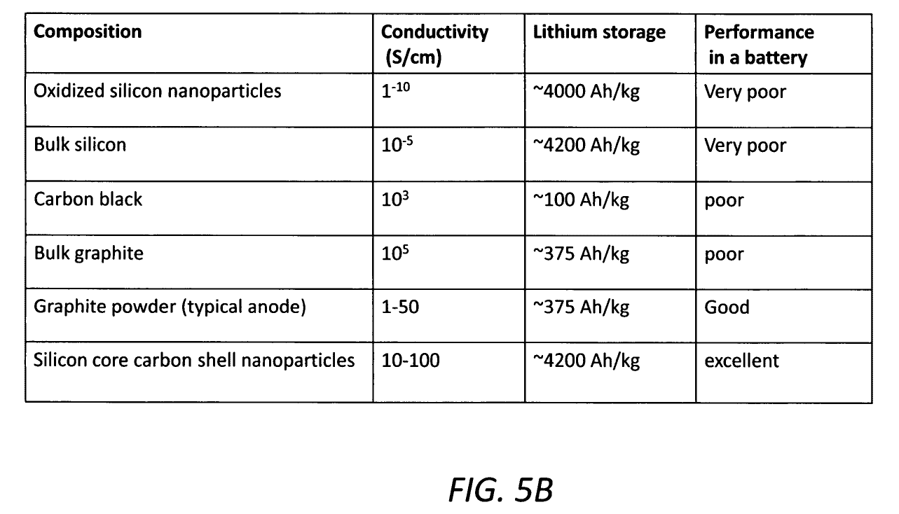

Referring to FIG. 5A, a simplified illustration is shown of a typical lithium ion battery, including a set of nanocomposite structures, in accordance with the invention. As previously described, cathode assembly 510 is generally comprised of cathode 505 that further includes a metal oxide, and an aluminum foil electrode 501 electrically and physically coupled to cathode 505. In an advantageous manner, anode 506 is comprised of a set of nanocomposite structures 504, electrically and physically coupled to aluminum foil electrode 502, the combination of both forming anode assembly 512. Cathode assembly 510 and anode assembly 512 are further physically separated via by porous membrane separator 203.

In one embodiment, anode assembly 512 may be assembled by dispersing the nanocomposite anode structure in N-Methyl-2-pyrrolidone (NMP) or water to form a slurry with the addition of other components such as a binder such as poly-vinyl difluoride (PVDF) and up to about 20% acetylene black carbon powder. The slurry may be coated onto the copper foil 502 with a slot coater and subsequently dried to form anode 506 as a coated layer. The coated layer will preferably have a thickness of less than about 50 microns, and more preferably a thickness of less than 30 microns.

Diameter of a typical nanocomposite particle 504 is preferably between about 1 micron and about 10 microns, more preferably between about 1 micron and about 5 microns. The inventors believe that this diameter range is beneficial for uniform coating thickness of anode 506.

The electrical conductivity of an anode 506 with a set of nanocomposite particles is preferably in the 1-100 S/cm range, and more preferably in the 10-100 S/cm range.

Referring to FIG. 5B, electrical conductivity of various single phase materials and composite materials are shown.

In general, carbon contributes to electrical connectivity and power density, whereas silicon contributes to the lithium-ion storage capacity. Both attributes are essential and tradeoffs need to be made for optimum performance. The carbon should preferably be as conductive as possible, preferable about 10³ S/cm or higher. The amount of carbon in the nanocomposite anode structure should preferably be less than about 33% of the mass, or more preferable less than 10% of the mass.

As set forth in the table above, although the silicon core generally does not provide a significant contribution to the conductivity of the nanocomposite anode structure the absence of insulating SiO₂ at the core-shell interface layer (shown as Oxidized silicon nanoparticles) directly enhances the electrical conductivity

In addition, the incorporation of conductive carbon particles or a conductive carbon phase, such as carbon black or graphite, may advantageously enhance the conductivity of the composite particle. In order to achieve high conductivity in the nanocomposite anode structure, preferably about 10 to about 100 S/cm.

Several example methods of nanocomposite anode structure fabrication are described below. The inventors believe that these techniques provide processes that can be scaled to produce large quantities of powder as required to supply the 10⁸ kg/year energy storage market.

An in line process can advantageously be used to nucleate and grow the silicon core in a first RF plasma reactor. In such a reactor a mixture of argon and silane gas pass through an RF plasma zone where a silicon core is nucleated form the silicon ions. The argon gas then carries there silicon cores to a second RF plasma zone where an organic precursor is added to the second plasma zone followed by grafting of the organic molecules onto the silicon core nanoparticles in said second downstream RF plasma. Examples of organic precursors include organic aliphatic chains such as 1-dodocene or mesitylene (see U.S. Pat. No. 8,945,674 entitled Nanoparticles with grafted organic molecules).

In one embodiment, these organic molecules may provide a precursor to from the carbon shell of the silicon core-shell particles. The grafting is preferable performed in the gas phase. An organic molecule source is provided and the organic molecules may be ionized, reduced and/or activated in a plasma to induce a chemical reaction with the nanoparticle surfaces.

In an example of this preferred process, nanoparticles are synthesized in a first plasma in less than a second and subsequently transferred into a second plasma, in which the ligands are subsequently attached within a few seconds. This provides an advantage in terms of time and processing ease. Moreover, this “in-flight” method generally allows attaching shorter molecules than is typically possible in the liquid phase.

An alternative liquid phase method can also be employed to produce a core-shell particle by grafting organic molecules on the surface of the silicon nanoparticles. For example, organic aliphatic chains can be grafted on the surface of the silicon by refluxing the silicon nanoparticles with a solvent, for example, including 1-dodocene and mesitylene. After hydrosilylation, the silicon nanoparticles may be separated by centrifugation, filtration, and/or by evaporating the solvent.

Modifying the surface of the silicon particles can minimize oxidation and stabilizing the silicon nanoparticles in various solvents. In the less preferred liquid phase approaches, one starts with a powder of agglomerated particles. The ligand molecules need to have a sufficient length such that they can overcome the van der Waals forces between particles to push agglomerated nanoparticles apart.

In yet another process, silicon particles can be coated with organic ligands by thermal gas-phase methods, for instance by flowing organic molecules through a furnace containing silicon particles such as in a tube furnace or in a rotary calciner.

In general, the plasma method provides advantages over liquid and gas phase thermal methods such as the ability to operate with a larger range of molecules than the thermal method. A non-thermal plasma generally selectively heats the particles in the plasma but leaves the background gas cold. The energetic charged species can dissociate and/or activate ligand molecules and produce reactive radicals which attach to the nanoparticle surfaces. The plasma approach can thus provide surface functionalization with a broader range of molecules such as alkanes which do not have any unsaturated bonds and are more difficult to activate thermally.

In a subsequent process the ligand molecules may substantially prevent agglomeration of the silicon nanoparticles in a solvent such as N-Methyl-2-pyrrolidone (NMP) or chloroform, thus exposing more surface of the core-shell nanoparticles to the carbon particles or porous carbon phase, to form a well dispersed composite electrode powder with minimal silicon agglomerates. This helps avoid the often undesirable agglomeration of individual silicon particles during formation of the silicon-carbon composite. Preventing agglomeration in the silicon carbon composite helps improve the mechanical integrity of the electrode due to volumetric changes during charge/discharge cycling. It may further help improve electrical conductivity provided by the carbon phase of the composite.

In addition, the silicon nanoparticle surface ligands can substantially delay silicon oxidation during subsequent processing including during the formation process of the silicon carbon composite particles in solvent or in water based chemistries.

In yet another method of surface functionalizing the silicon nanoparticles may comprise, for example: providing a hydrogen terminated silicon nanoparticle and modifying a surface of the silicon to include an organic aliphatic chain. For example, the surface of the silicon can be modified to include a 12 carbon long aliphatic chain. The surface of the silicon can then be modified prior to processing the silicon into a composite particle. The organic aliphatic chains can be grafted on the surface of the silicon by refluxing the silicon nanoparticles with a solvent, for example, including 1-dodocene and mesitylene. After hydrosilylation, the silicon nanoparticles can be separated by evaporating the solvent. Modifying the surface of the silicon particles can minimize oxidation and improve dispersion of the silicon nanoparticles in various solvents.

In another example, the carbon containing shell is a component or precursor to acetylene black that can be converted to acetylene black at a moderate temperature, such as below 550° C. Such a conductive carbon shell will improve the conductivity of the composite.

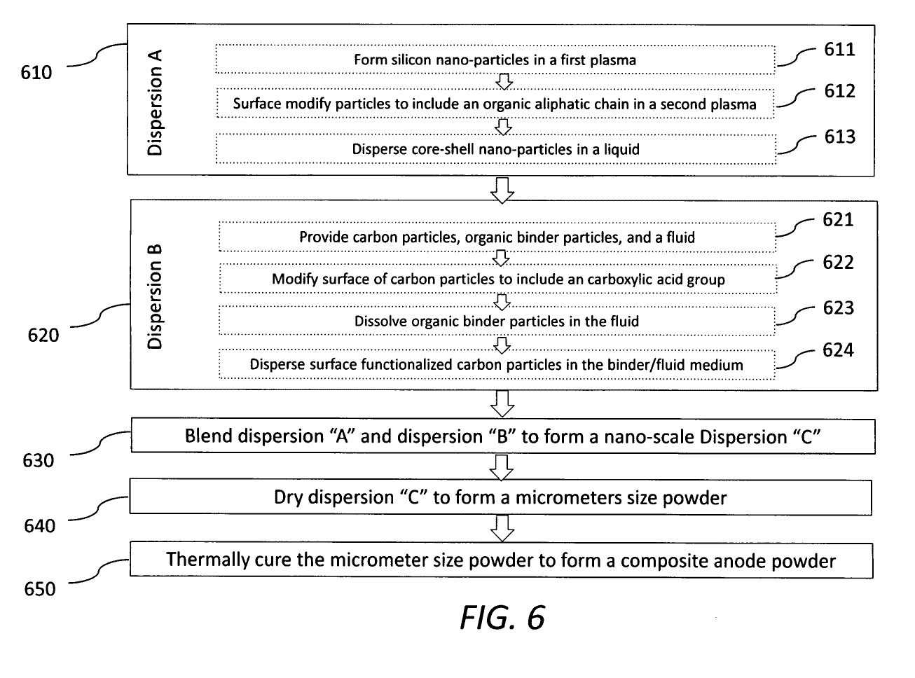

Referring now to FIG. 6, an example manufacturing process is shown to form a set of nanocomposite anode structures.

Initially, two dispersions are processed: Core-Shell Nanoparticle Dispersion A 610 and a Carbon Dispersion B 620,

Dispersion A 610 may be created by initially forming silicon nanoparticles at step 611 in a first RF plasma using a mixture of silane and argon. The formed silicon particles are then transferred at step 612 to a second RF plasma coupled to the first RF plasma, the second RF plasma comprising, for example, of argon and an organic precursor, in order to modify the nanoparticle surface with ligands, such as an organic 12 carbon long aliphatic chain.

In general, organic aliphatic chains can be grafted directly on the surface of the silicon preventing oxidation of the silicon surface during subsequent processing steps. These surface functional groups can further be selected for optimum dispersion in the preferred liquid such as N-Methyl-2-pyrrolidone (NMP). Minimizing core-shell nanoparticle agglomeration during dispersion in NMP is advantageous for the subsequent processing steps.

At step 613, the functionalized nanoparticles are then deposited into a solvent, completing Dispersion A.

Dispersion B 620 may be created by providing carbon particles, such as acetylene black, Ketjen black, soft carbon, hard carbon, graphitic carbon, graphite, carbon black, carbon nanotubes, or graphene, and organic binder of precursor particles such as Polyvinylpyrrolidone (PVP, also commonly called polyvidone or povidone), or Polyvinyl acetate (PVA, polyethenyl ethanoate) at step 621, modifying the surface of the carbon particles to include a carboxylic acid group at step 622. Optionally, the surface of the carbon particles may be modified with a set of carboxylic acid groups (—COOH) in order to enhance solubility and minimize agglomeration, which again may be advantageous for the subsequent processing steps. For example, the carbon particles can be treated in a mixture of sulfuric acid and nitric acid (3:1 volume percent) for 45 minutes.

At step 623 the binder particles are dispersed in a liquid such as PVP or water at step and subsequently dissolved by for example stirring and or heating. PVP is preferably used. Alternatively water may also be used as the appropriate solvent for the polymer binder powder. Such binders may be advantageously added in a weight ratio of up to 1:1 relative to the core-shell particle weight added to dispersion A, as the polymer binder decomposition at high temperature leads to the presence of an amorphous carbon residue in the annealed structure. For the case of PVP as an example PVP is known to decompose into a carbonaceous structure with a mass yield between 4% and 15% depending on the annealing conditions and on the presence of other additives mixed with the PVP. [See: A Stable Silicon Anode Based on the Uniform Dispersion of Quantum Dots in a Polymer Matrix, L. Zhong et al., Journal of Power Sources 2015, Vol. 273, pp. 638-644].

At step 624 the carbon particles are subsequently mixed with dissolved polymer to from a mixed dispersion comprising carbon particles and the dissolved polymer binder PVP or PVA.

At step 630, Dispersion A and Dispersion B are blended to from Dispersion C.

At step 640, the silicon core-shell nanoparticles and carbon particles are incorporated into a PVP or PVA polymer matrix as a composite particle by spaying drying the mixed dispersion to form micron size droplets and drying the liquid to form micron size composite particles. The preferred dried particle size being in the range between 0.1 and 10 μm, even more preferably between 1 μm and 5 μm in one preferred process, this is preferably done using a spray dryer. The peak processing temperatures in the spray drying process is typically inadequate to fully convert the surface functional group to its final functional carbon shell with the appropriate chemical barrier and electrical properties.

In certain process implementations, the peak processing temperature during spray-drying may further be inadequate to create strong chemical bonding between the individual nanoparticles comprising the composite particles.

In certain process implementations, the peak processing temperature during spray-drying may further be inadequate to fully convert the PVP or PVA poly matrix to its final functional carbon form with the appropriate chemical barrier, physical encapsulation, and electrical properties.

At step 650, the nanoparticles may be dried in a rotary calcining furnace into which spray dried composite particles are loaded. The ambient used is preferably pure nitrogen or argon while heating the furnace to below about 750° C. for less than about 30 min. In one embodiment, the furnace is heated to about 650° C. and the particle residence time in the hot zone of the furnace is 10 minutes. In such a process the organic ligands can be fully converted to the final functional carbon shell with the appropriate chemical barrier and electrical properties. In such a process the organic ligands can be fully converted to the final functional carbon shell with the appropriate chemical barrier and electrical properties.

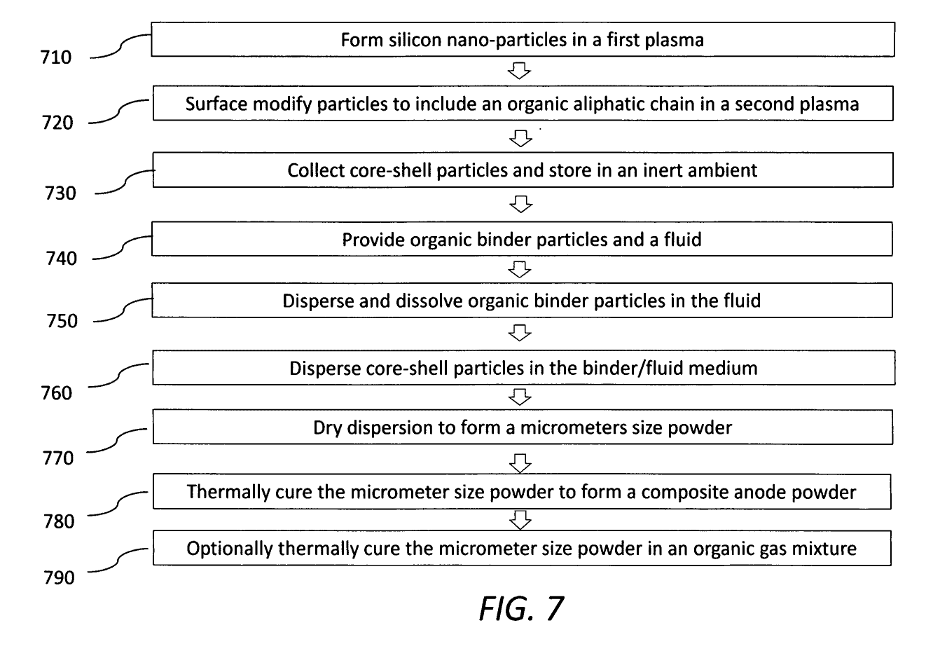

Referring now to FIG. 7, a first alternative manufacturing process is shown to form a set of nanocomposite anode structures, in accordance with the invention.

Initially, at step 710, silicon nanoparticles are formed in an RF plasma using a mixture of silane and argon.

The silicon particles are then transferred at step 720 to a second RF plasma coupled to the first RF plasma, the second RF plasma comprising, for example, of argon and an organic molecule, in order to surface coat the nanoparticles to include an organic group, such as an organic 12 carbon long aliphatic chain that will subsequently be converted to a carbon shell. It is desirable to use a molecule with low level of polymerization in an RF plasma during this surface coating process.

At step 730, the nanoparticles are removed from the plasma reactor, collected and stored, preferably under a blanket of an inert gas such as nitrogen or argon.

At step 740 an organic binder powder and a fluid is provided. The organic binder particle can be for example a polymer particle such as Polyvinylpyrrolidone (PVP, also commonly called polyvidone or povidone), or Polyvinyl acetate (PVA, polyethenyl ethanoate). The fluid or liquid can be for example N-Methyl-2-pyrrolidone (NMP) or water. These binder particles are dispersed in a liquid such as NMP or water at step 750 and subsequently dissolved by for example stirring and or heating in step 750. PVP is preferably used. Alternatively water may also be used as the appropriate solvent for the polymer binder powder. Such binders may be advantageously added in a weight ratio of up to 1:1 relative to the core-shell particle weight as the polymer binder decomposition at high temperature leads to the presence of an amorphous carbon residue in the annealed structure. For the case of PVP as an example PVP is known to decompose into a carbonaceous structure with a mass yield between 4% and 15% depending on the annealing conditions and on the presence of other additives mixed with the PVP. At subsequent processing step 760 the dispersed core-shell nano-silicon particles from step 730 are subsequently mixed with dissolved polymer from step 750 to from a mixed dispersion comprising nano-dispersion of silicon core-shell particles and the dissolved polymer binder PVP or PVA.

In a subsequent preferred process step 770, the silicon core-shell nanoparticles are incorporated into a PVP or PVA polymer matrix as a composite particle by spaying drying the mixed dispersion to form micron size droplets. Preferably drying the liquid using a spray dryer, the generated micron size droplets form micron size core-shell polymer composite particles with a size preferably between 0.1 μm and 10 μm, and more preferably with a size between 1 μm and 5 μm.

However, the processing temperatures generated during the spray drying process may not be sufficiently high to fully convert the surface functional group to its final functional carbon shell with the appropriate chemical barrier and electrical properties, or to fully convert the PVP or PVA poly matrix to its final functional carbon form with the appropriate chemical barrier, physical encapsulation, and electrical properties. Consequently, a subsequently higher temperature process may need to be use.

For example, at step 780, the nanoparticles may be thermally cured in a rotary calcining furnace performed in a rotary calcining furnace into which spray dried composite particles are loaded. This step is performed to convert the organic shell into a carbon shell and to create a conductive percolation network. This step is further performed to convert the binder into a carbon residue, such as amorphous carbon to reduce the open porosity of the final composite micron size particles.

The ambient used is preferably pure nitrogen or argon while heating the furnace to below about 650° C. for less than about 30 min. In one embodiment, the furnace is heated to about 550° C. and the particle residence time in the hot zone of the furnace is about 10 minutes.

At step 790, an optional additional chemically vapor assisted heat treatment may be performed in a rotary calcining furnace. The powder is heated in a gas mixture comprising nitrogen, further comprising hydrogen in concentration from about 0 to about 10%, further comprising an organic component such as methane, ethane, ethylene, or similar small organic molecules in concentrations from about 0 to about 30% while heating the furnace to below about 650° C. for less than about 20 min.

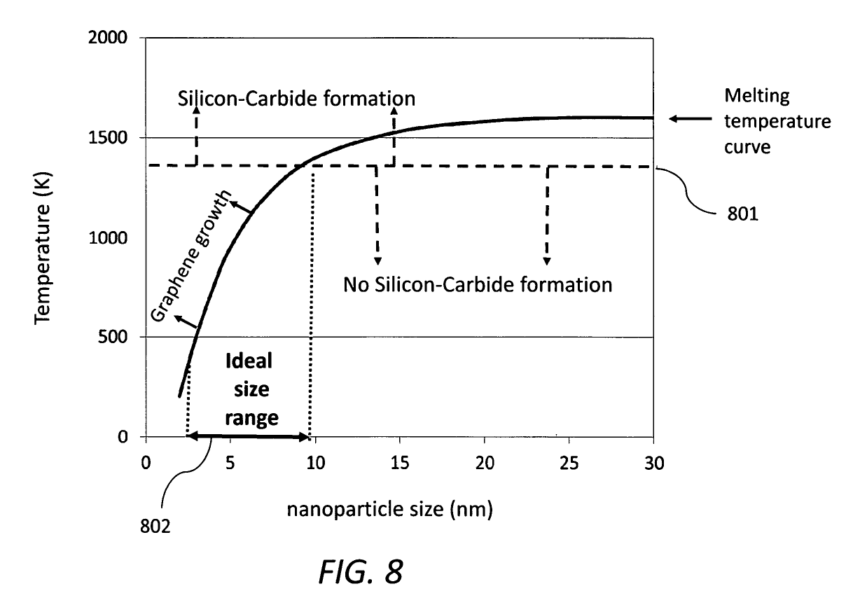

In one embodiment of the present invention, the rotary calcining furnace is heated to about 650° C. and the particle residence time in the hot zone of the furnace is about 10 minutes. In such a process, the organic ligands may be fully converted to a final functional carbon shell with the appropriate chemical barrier and electrical properties. In another embodiment, the rotary calcining furnace is heated to about 750° C. to facilitate the formation of a crystalline carbon phase on the surface of the core-shell particles, or preferably, a multilayer graphene phase, as set forth in FIG. 8.

Referring now to FIG. 8, a graph is depicted representing the melting temperature in Kelvin as a function of silicon nanoparticle size in nm, as taught by Goldstein (see U.S. Pat. No. 5,576,248 entitled Group IV semiconductor thin films formed at low temperature using nanocrystal precursors). In particular, Goldstein teaches that the melting temperature of silicon decreases below the melting point of bulk silicon at 1414° C. (1687 K) for small particles. This has been demonstrated generally for silicon particle size below a certain size such as below 20 nm. By way of example, the melting temperature of silicon in a 10 nm particle is below about 1100° C.

In general, processing temperatures close to the melting point of silicon are required to template crystalline carbon surface coatings such as graphite or graphene like carbon structures on a silicon surface, in order to impart the desirable electrical conductivity, chemical, and mechanical properties associated with such graphene.

However, at a temperature threshold of about 1373° K (801), bulk silicon carbide (SC) will tend grow on a silicon surface in the presence of carbon containing elements. In general, bulk SC tends to have negative effects on anode performance as SC does not store lithium and can further block lithium diffusion into and out of the silicon core.

Consequently, at temperatures of above about 1373° K, it tends to become necessary to grow a SiO₂ coating between the graphene outer shell and the silicon core to prevent silicon carbide formation. Using this process, graphene growth has been demonstrated at about 1373° K on a silicon core particle with a SiO₂ shell and a particle size between about 100 nm and about 150 nm [see Hyuk Son et al., Silicon carbide-free graphene growth on silicon for lithium-ion battery with high volumetric energy density, Nature Communications 6, Article number: 7393 (2015)].

However, in an advantageous manner, the use of silicon core particles below about 10 nm allows graphene to form and template onto the silicon core surface at temperatures well below 1373° K without also forming SC.

It thus generally becomes possible to form graphene-like shells on small nanoparticle silicon cores such as on sub-10 nm silicon cores at temperatures well below 1373° K. Under such condition, bulk SC formation can be avoided without the need to grow a SiO₂ layer in between the silicon core and the carbon shell.

Consequently, the use of silicon nanoparticles with a size of between about 2 nm and about 10 nm will advantageously provide the unique conditions to induce a stable Si—C interface to catalyze growth of graphene like conductive shell. This ideal size range 802 allows graphene growth at temperatures substantially lower than 1373° K (1100° C.) such as at temperatures as low as about 550° C., much lower than about 1100° C. as has been taught in the prior art. [see Hyuk Son et al, Silicon carbide-free graphene growth on silicon for lithium-ion battery with high volumetric energy density, Nature Communications 6, Article number: 7393 (2015)].

For example, a highly crystalline coating such as graphene like coating can be performed in a rotary calciner type furnace into which spray dried composite particles are loaded. The powder is then heated in a gas mixture comprising nitrogen, further comprising hydrogen further comprising an organic component such as methane, ethane, ethylene, or similar small organic molecules known in the art. While heating the furnace to less than 750° C. In one embodiment, a graphene shell can be grown on particles with a silicon core diameter of less than about 10 nm and at a temperature when the particle residence time in the hot zone of the furnace is about 10 minutes.

The invention has been described with reference to various specific and illustrative embodiments. However, it should be understood that many variations and modifications may be made while remaining within the spirit and scope of the invention.

Having disclosed exemplary embodiments and the best mode, modifications and variations may be made to the disclosed embodiments while remaining within the subject and spirit of the invention as defined by the following claims.

What is claimed is:

1. A nanocomposite comprising:
a set of substantially dispersed nanoparticles configured to absorb and release lithium ions, wherein each nanoparticle of the set of nanoparticles comprises a core and a shell physically coupled to the core, the core further comprising a set of bonded silicon atoms, the shell further comprising a set of bonded carbon atoms, wherein a core diameter is less than about 20 nm, and wherein the shell has a thickness of about 0.1 to about 2 nm; and,
a set of electrically coupled carbon particles substantially dispersed in the nanocomposite, wherein the set of carbon particles are further electrically coupled with the set of nanoparticles.

2. The nanocomposite of claim 1, wherein the set of bonded carbon atoms are configured as a set of graphene layers.

3. The nanocomposite of claim 1, wherein a boundary between the core and the shell further includes silicon-carbon bonds.

4. The nanocomposite of claim 1, wherein a boundary between the core and the shell further includes less than about 20% silicon-oxygen bonds.

5. The nanocomposite of claim 1, wherein a majority of the set of electrically coupled nanoparticles has a core diameter of less than about 15 nm.

6. The nanocomposite of claim 1, wherein a majority of the set of substantially dispersed nanoparticles has a core diameter of less than about 10 nm.

7. The nanocomposite of claim 1, wherein the cores at least some of the nanoparticles are physically coupled.

8. The nanocomposite of claim 1, wherein a subset of the set of carbon particles physically contact a subset of the set of nanoparticles.

9. The nanocomposite of claim 1, wherein the set of carbon particles comprise acetylene black and ketjen black powder.

10. The nanocomposite of claim 1, wherein the carbon comprises soft carbon

11. The nanocomposite of claim 1, wherein the carbon comprises hard carbon

12. A method of forming a nanocomposite comprising steps of:
adding a set of nanoparticles to an organic solvent, each nanoparticle of the set of nanoparticles comprising
(a) a silicon core and a surface layer comprising a set of silicon-carbon bonds, and
(b) an organic ligand coupled to the surface layer, the organic ligand configured to create a substantially stable colloidal dispersion in the organic solvent;
adding a set of carbon particles and an organic precursor material to a second solvent;
mixing the first solvent with the second solvent such that a composite liquid dispersion is formed;
drying the composite liquid dispersion to form a composite powder;
heating the composite powder such that
(a) for each nanoparticle, a carbon shell is formed, and
(b) a porous carbon phase is formed, the set of nanoparticles are dispersed within the porous carbon phase.

13. The method of claim 12, wherein prior to the step of adding a set of carbon particles to a second solvent, adding a carboxylic acid group to a surface layer of the set of carbon particles.

14. The method of claim 12 wherein the organic precursor is one of Polyvinylpyrrolidone (PVP) and Polyvinyl acetate (PVA).

15. The method of claim 12, wherein at least one of the first solvent and the second solvent is NMP

16. A method of forming a nanocomposite, comprising steps of:
adding an organic binder to a solvent and dissolving said binder in the solvent to from a medium;
adding a set of nanoparticles to an said medium, each nanoparticle of the set of nanoparticles comprising
(a) a silicon core and a surface layer comprising a set of silicon-carbon bonds, and
(b) an organic ligand coupled to the surface layer, the organic ligand configured to create a substantially stable colloidal dispersion in the medium;
Dispersing the nanoparticles in the medium such that a composite liquid dispersion is formed;
drying the composite liquid dispersion to form a composite powder;
heating the composite powder such that
(a) for each nanoparticle, a carbon shell is formed substantially encapsulating the nanoparticle, and
(b) a porous and electrically connected carbon phase is formed, the set of nanoparticles are dispersed within the porous carbon phase.

17. The method of claim 16 wherein the organic precursor is one of Polyvinylpyrrolidone (PVP) and Polyvinyl acetate (PVA).

18. The method of claim 16, wherein the drying method involves the formation of droplets

19. The method of claim 16, wherein the carbon shell is substantially crystalline

20. The method of claim 16, wherein the carbon shell comprises multilayered graphene.
